(19) United States
(12) Patent Application Publication
(10) Pub. No.: US 2014/0064026 A1
(43) Pub. Date: Mar. 6, 2014

(54) WAVE GLIDER WITH STREAMER ORIENTATION SENSOR

(71) Applicant: Apache Corporation, Houston, TX (US)

(72) Inventors: David J. Monk, Brazoria, TX (US); Michael S. Bahorich, Houston, TX (US)

(73) Assignee: Apache Corporation, Houston, TX (US)

(21) Appl. No.: 13/945,219

(22) Filed: Jul. 18, 2013

Related U.S. Application Data
(60) Provisional application No. 61/696,334, filed on Sep. 4, 2012.

(51) Int. Cl. G01V 1/38; B63H 1/37

(52) U.S. Cl. CPC G01V 1/3835; B63H 1/37
USPC 367/19; 440/9

(57) ABSTRACT

A wave glider system includes a float having geodetic navigation equipment for determining a geodetic position and heading thereof. The glider includes an umbilical cable connecting the float to a sub. The sub has wings operable to provide forward movement to the float when lifted and lowered by wave action on the surface of a body of water. At least one geophysical sensor streamer is coupled to the sub. The at least one geophysical sensor streamer has a directional sensor proximate a connection between the sub and one end of the at least one geophysical sensor streamer to measure an orientation of the streamer with respect to a heading of the float.

### CROSS-REFERENCE TO RELATED APPLICATIONS

Priority is claimed from U.S. Provisional Application No. 61/696,334 filed in Sep. 4, 2012 and incorporated herein by reference in its entirety.

### STATEMENT REGARDING FEDERALLY SPONSORED RESEARCH OR DEVELOPMENT

Not applicable.

### BACKGROUND

This disclosure relates generally to the field of wave gliders. More specifically, the disclosure relates to wave gliders used to move seismic sensor streamers through a body of water.

A wave glider is a two part water borne vessel that uses energy of wave motion for propulsion. A float component operates proximate the water surface and may include various electronic communication and navigation devices to enable the wave glider to follow a predetermined geodetic trajectory or a remotely guided trajectory. A sub component is suspended from the float part at a selected depth in the water by a substantially rigid umbilical cable and includes articulated wings.

Wave motion is greatest at the water's surface, decreasing rapidly with increasing depth. The wave glider's two-part architecture exploits this difference in motion to provide forward thrust. A rising wave lifts the float, causing the tethered sub to rise. The articulated wings on the sub are pressed down and the upward motion of the sub becomes an up-and-forward motion, in turn pulling the float forward and off the wave. This causes the sub to drop. The wings pivot up, and the sub moves down-and-forward. This process is repeated again and again as long as there is wave motion on the surface, even the smallest amount. The wave glider may be equipped with global positioning system (GPS) receivers and computers for navigation and payload control, with satellite communication systems, and with selected ocean sensors to monitor and measure the environment around it. The power needed to operate the sensors and computers may be provided by solar panels.

An example of a wave glider is sold by Liquid Robotics, Inc., 1329 Moffett Park Drive, Sunnyvale, Calif. 94089.

More recently it has been proposed to use wave gliders to tow seismic sensor streamers. Because of the limitations of the power supply on the float of the wave glider, ordinary streamer navigation devices such as compass birds may exceed the limits of available power to determine the geodetic trajectory of a streamer being moved by a wave glider. Furthermore the seismic streamer may not necessarily follow the path of motion taken by the wave glider as it will be subject to different currents and associated forces. The seismic steamer may be behind, to the side or in front of the wave glider as it moves. While the direction and orientation of the wave glider may be known on the surface, the orientation of the seismic streamer may be different.

There exists a need for a seismic streamer navigation system that uses little electrical power when towed by a wave glider.

### SUMMARY

A wave glider system according to one aspect includes a float having geodetic navigation equipment for determining a geodetic position and heading thereof. The glider includes an umbilical cable connecting the float to a sub. The sub has wings operable to provide forward movement to the float when lifted and lowered by wave action on the surface of a body of water. At least one geophysical sensor streamer is coupled to the sub. The at least one geophysical sensor streamer has a directional sensor proximate a connection between the sub and one end of the at least one geophysical sensor streamer to measure an orientation of the streamer with respect to a heading of the float.

Other aspects and advantages of the invention will be apparent from the description and claims which follow.

### BRIEF DESCRIPTION OF THE DRAWINGS

FIG. 1 shows an example of a seismic source vessel with example source arrays being towed in a body of water.

FIG. 2 is an overview of an example wave glider towing a seismic streamer.

### DETAILED DESCRIPTION

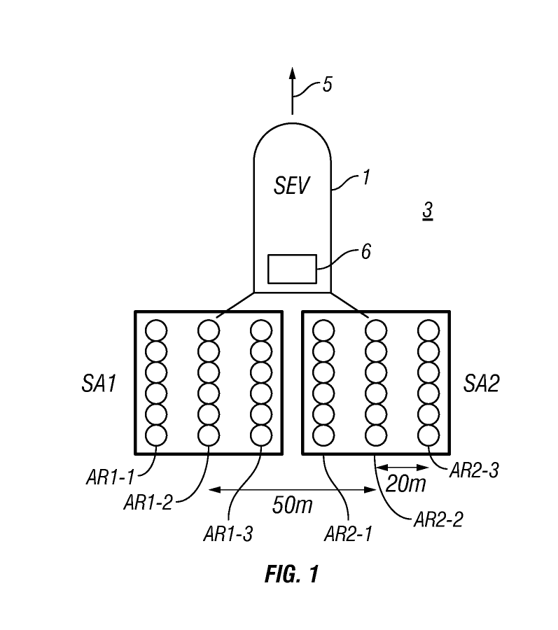

FIG. 1 shows a non-limiting example of seismic energy sources which may be towed in a body of water 3 by a source vessel 1. The sources may be, for example, air guns, water guns or similar impulsive sources, or marine vibrators. The type of source is not intended to limit the scope of the present disclosure. Source array SA1 which may be considered to be composed of, for example, three sub arrays, AR1-1, AR1-2, AR1-3 separated from each other laterally (transverse to the vessel heading) by, for example, 20 meters. Corresponding sub arrays are shown at AR2-1, AR2-2 and AR2-3 for a second source array SA2. The source arrays may be towed by a source vessel It would therefore be possible to activate the center (AR1-2) and port (AR1-1) sub array, the center (AR1-2) and starboard (AR1-3) sub array, or the two outer (port and starboard sub arrays (AR1-1 and AR1-3). If the sub arrays are substantially identical in configuration, and sufficiently laterally separated such that there is negligible interaction between them when actuated, then the same far field vertical energy signature would result from each combination of activated sub arrays, but the effective position of the source would vary in a direction perpendicular to the vessel travel path 5. The sub-arrays may be actuated in certain sequences to enhance the efficiency of seismic data acquisition. One non-limiting example of such sequences is described in U.S. Pat. No. 6,882,938 issued to Vaage et al. It should be noted that 3 sub arrays is not a limit to the configuration of the source array, and more sub-arrays may be deployed in other implementations. Using more sub arrays increases the number of possible activation positions of the source(s). Further, actuation of the sources as described above is only intended as an example and is not a limit on the scope of the present disclosure. For purposes of defining the scope of the present disclosure, only one source may be used. Further, any one or more of the sources may be an electromagnetic signal transmitter, for example a time domain or frequency domain controlled source transmitter for the purpose of conducting electromagnetic surveys.

The vessel 1 may have onboard equipment, shown generally at 6, which may be referred to for convenience as a “recording system.” The recording system 6 may include devices (not shown separately) for navigation of the vessel 1, determining its geodetic position at any moment in time (such as by using a global position system [GPS] satellite receiver), a precision clock (such as may be obtained by detection of GPS signals, and a processor or other computer for controlling actuation of the source(s). A record of actuation time(s) of the source(s) may be made in a data storage device forming part of the processor or computer in the recording system 6.

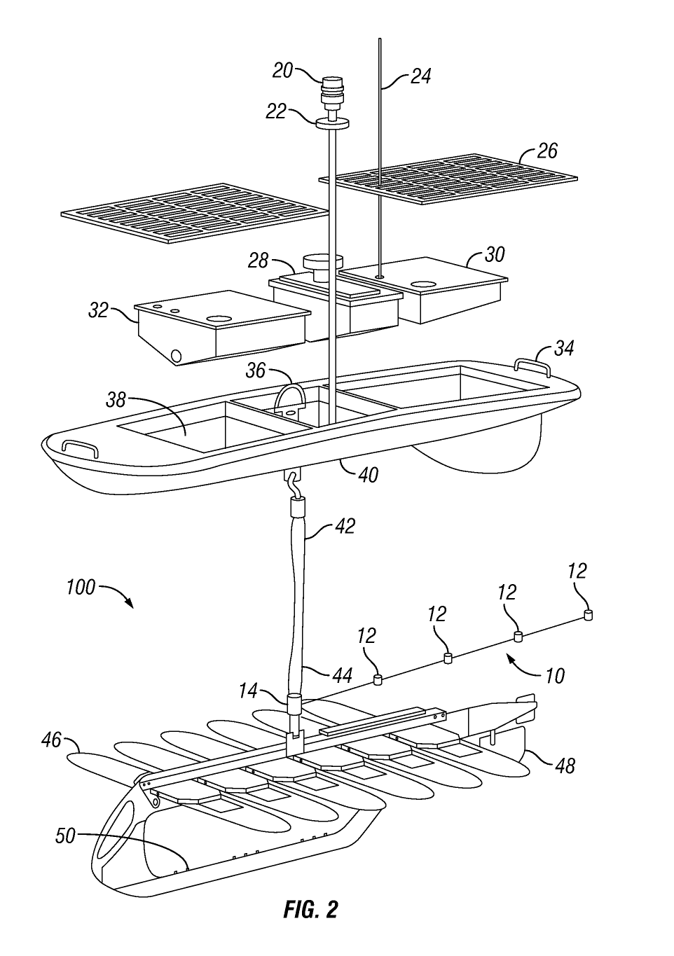

As is known in the art, when actuated, the one or more source(s) emits seismic energy into the body of water 3. Some of the seismic energy travels through formations below the water bottom, is reflected by acoustic impedance boundaries in the subsurface and may be detected by one or more seismic sensors disposed along one or more streamers towed by respective wave gliders as will be explained below with reference to FIG. 2.

An example wave glider with attached seismic sensor streamer and streamer orientation sensor is shown in exploded view at 100 in FIG. 2. The wave glider 100 may include a float 40 having a forward 32 and aft 30 payload bay, in each of which may be disposed a weatherproof, watertight sealed container (“dry box”). Command and control electronics (not shown separately), which may include autonomous or remotely operable navigation controls may be located in either dry box or in a centrally located dry box 26. Electrical power to operate the command and control electronics (not shown separately) may be provided by solar panels 26 (and which may charge batteries or energy storage devices disposed in one or more of the dry boxes). The electronics may include recording devices for signals generated by seismic sensors 12 disposed at spaced apart locations along a seismic streamer 10. The seismic sensors 12 may be particle motion, velocity or acceleration responsive sensors, pressure or pressure gradient responsive sensors, or any combination of the foregoing sensor types . Optional devices mounted above the float 40 may include a weather station 20 (which may record, e.g., wind speed and direction, barometric pressure, air and/or water temperature and air humidity), marker light 22 and communication antenna 24.

The float 40 is connected to a sub 44 by a substantially rigid umbilical cable 42. The umbilical cable 42 may include electrical conductors and/or optical fibers to communicate signals to operate a rudder 48 forming part of the sub 44. The sub 44 has articulated wings 46 mounted on a frame 50 so that upward and downward motion of the float 40 caused by wave action on the water surface (3 in FIG. 1) causes the wings 46 to impart forward motion to the frame 50, and thus to the float 40 because of its connection to the sub 44 through the umbilical cable 42. The wave glider may be steered by the control electronics (not shown separately) in the dry box 28 in the float 40.

In towing a seismic sensor streamer, it may be assumed that the streamer 10 extends directly behind the sub (and thus the float) along the direction of motion of the float. Depending on currents in the water, wave direction on the surface, and surface winds acting on the wave glider, however, this may not always be the case. Accordingly, in one aspect, a direction of the streamer with respect to the heading of the float may be determined using an angular orientation sensor or directional sensor, shown generally at 14, at the front end of the streamer 10 where it is mounted to the sub frame. The angular orientation sensor may be, for example, a rotary encoder that measures an angle subtended by the encoder output with respect to an absolute reference or a relative reference, e.g., mounted in a specific orientation relative to the frame, while the geodetic heading of the float may be determined using a GPS receiver or similar geodetic navigation device. One non limiting example of a rotary encoder is sold by Dynapar, 1675 N. Delany Rd., Gurnee, Ill. 60031 under model series number AX70. It is also possible to use flux gate magnetometers to determine the geomagnetic direction of the streamer, and relate such determined direction to the geodetic heading of the float from the GPS receiver (not shown).

Having such directional sensor 14 at the forward end of the streamer 10 may provide the system operator with more accurate location of each of the seismic sensors 12 when recordings of seismic energy are made. Such recordings may be made on a low power consumption device such as a solid state memory, for example, so that the power capacity of the solar panels 26 is not exceeded. It is within the scope of the present disclosure for the electronic circuitry to have programmed in memory time(s) at which the one or more sources (FIG. 1) are actuated, and signal recording of the output of the sensors 12 along the streamer 10 may be initiated at such times and stopped after a selected recording interval, depending on the type of sensor and the type of energy source used. Such recording sequence may reduce the amount of power consumed by the electronics. During operation of the wave glider system 100, at each recording interval, a geodetic position and geodetic or geomagnetic heading of the float 40 may be determined as explained above. Using the signals from the directional sensor 14, which may be recorded contemporaneously with each recording interval, an approximate geodetic position of each sensor 12 on the streamer may be determined without the need to have additional energy consuming devices such as compass birds or geodetic position signal receivers associated with each sensor 12.

While the foregoing example is described in terms of seismic sensors, it will be apparent to those skilled in the art that a streamer having any type of geophysical sensors may also be used in accordance with the present example. Such sensors may include, without limitation, temperature sensors, electric field sensors, magnetic field sensors and electrical conductivity sensors. While determination of the relative position of a single sensor directly attached to the sub, or attached at a short distance may not require determination of angle made between the streamer and the sub, if the streamer has any significant length greater than the length of the sub, then significant errors in determined position may occur without utilization of a directional sensor as described herein. Accordingly, for purposes of defining the scope of the invention, the term “geophysical sensor streamer” may be used to describe the streamer 10 coupled to the sub frame.

It is also within the scope of the present disclosure to use “passive” geophysical sensors that detect naturally occurring energy, such as from microseismic events originating in the subsurface, Earth magnetic field and magnetotelluric signals. Accordingly, the source vessel and associated source(s) shown in FIG. 1 may not be used in some implementations.

It is within the scope of the present disclosure to conduct a geophysical survey with a plurality of wave glider systems operating contemporaneously and spaced apart so as to enable relatively large areal coverage of the subsurface in a relatively time efficient manner.

While the invention has been described with respect to a limited number of examples, those skilled in the art will readily devise other examples which do not exceed the scope of the invention. Accordingly, the invention shall be limited in scope only by the attached claims.

What is claimed is:

1. A wave glider system comprising:
a float, the float including geodetic navigation equipment for determining a geodetic position and heading of the float;
an umbilical cable connecting the float to a sub, the sub having wings operable to provide forward movement to the float when lifted and lowered by wave action on the surface of a body of water; and
at least one geophysical sensor streamer coupled to the sub, the at least one geophysical sensor streamer having a directional sensor proximate a connection between the sub and one end of the at least one geophysical sensor streamer, the directional sensor for measuring an orientation of the streamer with respect to a heading of the float.

2. The wave glider system of claim 1 wherein the directional sensor comprises a rotary encoder.

3. The wave glider system of claim 1 wherein the directional sensor comprises a geomagnetic direction sensor.

4. The wave glider system of claim 1 wherein the geophysical sensor streamer comprises at least one of a seismic sensor streamer, an electric field sensor streamer, a magnetic field sensor streamer and an electrical conductivity sensor streamer.

5. A method for geophysical surveying, comprising:
detecting energy from formations below a bottom of a body of water, the detecting performed at each of a plurality of geophysical sensors disposed at spaced apart locations on at least one streamer towed by a wave glider;
determining a geodetic position and at least one of a geodetic and geomagnetic heading of the wave glider at a time of the detecting; and
estimating a geodetic position of each of the plurality of geophysical sensors by measuring a parameter related to an angle of the at least one streamer with respect to the at least one of a geodetic and geomagnetic heading of the wave glider.

6. The method of claim 5 wherein the parameter comprises angle measured by a rotary encoder.

7. The method of claim 5 wherein the parameter comprises geomagnetic heading measured by a geomagnetic direction sensor.

8. The method of claim 5 wherein the energy originates from a controlled geophysical energy source disposed in the body of water.

9. The method of claim 8 wherein the energy source comprises a seismic energy source or arrays thereof
